(19) United States
(12) Patent Application Publication
(10) Pub. No.: US 2004/0062709 A1
(43) Pub. Date: Apr. 1, 2004

(54) Powder of tantalum oxide or niobium oxide, and method for production thereof

(76) Inventors: Kenji Higashi, Tokyo (JP); Hiroyuki Watanabe, Tokyo (JP); Norihiko Miyashita, Saitama (JP)

Correspondence Address: ROTHWELL, FIGG, ERNST & MANBECK, P.C., 1425 K STREET, N.W., SUITE 800, WASHINGTON, DC, 20005, US

(21) Appl. No.: 10/467,672

(22) PCT Filed: Dec. 26, 2002
(86) PCT No.: PCT/JP02/13631

(30) Foreign Application Priority Data
Dec. 27, 2001 (JP) 2001398601

(51) Int. Cl. C01G 1/00

(52) U.S. Cl. 423/594.17

(57) ABSTRACT

The present invention provides high-quality tantalum oxide or niobium oxide powders with more stable quality. These high-quality tantalum oxide or niobium oxide powders have an extremely high lightness of color, having an L* value from 97 to 100 both inclusive in the L*a*b* color system. These powders contain a small amount of impurities and have a stable form of pentoxide. To produce the above described tantalum oxide or niobium oxide powders having an extremely high lightness of color, oxygen is sufficiently supplied to a roasted product in a roasting step and a subsequent high-temperature step which are both carried out during their production process.

### TECHNICAL FIELD

The present invention relates to high-purity tantalum oxide or niobium oxide powders that are used as optical materials, electronic materials and the like, and a method of producing these powders.

### BACKGROUND ART

Tantalum oxide or niobium oxide powders have been used as additives to optical glasses, or as materials for lithium tantalate or lithium niobate single crystals to be used with the substrates of surface wave devices, and demand for these powders has increased.

Tantalum oxide or niobium oxide powders are generally produced by adding ammonium or the like into a solution comprising tantalum or niobium so as to obtain a precipitate that is the hydroxide of tantalum or niobium, and roasting the precipitate. Tantalum oxide or niobium oxide powders used for the above described purposes preferably contain only a few amount of impurities. Thus, impurities are eliminated in the production stage, so that the level of impurities is reduced and the purity of tantalum oxide or niobium oxide is increased. In order to eliminate impurities from a crude tantalum or crude niobium compound in the production stage, solvent extraction has been mainly used.

Solvent extraction involves adding hydrofluoric acid or mixed acid of hydrofluoric acid and sulfuric acid to materials containing tantalum and/or niobium, extracting tantalum and/or niobium from the obtained solution using methyl isobutyl ketone (MIBK), and eliminating other impurities, e.g., metals such as iron and manganese. In addition, as disclosed in Japanese Patent Laid-Open Nos. 60-21343, 63-236716 and 64-45325, there is another method, which preferentially extracts tantalum existing in a hydrofluoric acid solution or mixed solution of hydrofluoric acid and sulfuric acid, using an organic solvent obtained by selecting from a group consisting of ketones, neutral phosphates, alkylamines and alkylamides and then diluting with petroleum hydrocarbon, so that tantalum is separated from other metal ions. These solvent extraction methods enable to reduce the level of impurities and to increase the purity of tantalum oxide or niobium oxide.

By the way, Czochralski process, which comprises filling raw materials in a crucible, melting them by heating, dipping a seed crystal thereinto, and pulling the seed crystal upwards while rotating it at the same time, has widely been used in the production of the single crystals of lithium tantalate or lithium niobate, which are used for the substrate of an elastic surface wave device. It is known that this method uses a congruent composition in which the composition of the crystal matches with that of the melt. However, it is not easy to exactly match the compositions of the two materials so as to obtain the congruent composition. If the melt composition (composition ratio) is deviated, the composition of the obtained crystal is fluctuated, thereby resulting in variation in the yield of an elastic surface wave device produced.

Thus, various methods for obtaining a composition of a melt of interest have been proposed up till now.

For example, Japanese Patent Publication No. 3-24438 discloses a production method in which the molar ratio of Li/Ta is set at 0.937±0.004 in the composition of raw materials for growing lithium tantalum single crystals, so that the molar ratio of Li/Ta in the composition of the obtained crystals is stabilized at 0.935±0.006.

The composition ratios of the melts of raw materials for lithium niobate, lithium carbonate and niobium oxide may differ from composition ratios of interest due to unnecessary components contained in the raw materials. In order to prevent this problem, Japanese Patent Laid-Open No. 6-48896 discloses a method of obtaining the uniformed single crystals of lithium niobate, which comprises obtaining the amount of the raw materials, lithium carbonate and niobium oxide that is reduced by heating, determining the content of unnecessary components from the amount reduced by heating, and weighing each raw material so as to obtain a congruent composition (composition ratio of interest).

However, in order that the composition of the melt is exactly matched with the congruent composition to obtain lithium tantalate or lithium niobate single crystals having a composition of interest, strictness is required for the composition of the raw materials of the melts. This is to say, tantalum oxide or niobium oxide powders, as raw materials, should contain further reduced impurities, and the quality of the powders should be stable.

The present invention is made to solve the above problems. It is the object of the present invention to provide high-quality tantalum oxide or niobium oxide powders with reduced impurities and further stable quality, and a production method thereof.

### BRIEF DESCRIPTION OF THE DRAWING

FIG. 1 shows a production process of the tantalum oxide or niobium oxide powders of the present invention.

### DISCLOSURE OF THE INVENTION

In order to achieve the above object, the present inventors have studied the production process or properties of tantalum oxide or niobium oxide powders. As a result, they have found that the whiteness degree of the tantalum oxide or niobium oxide powders increases as the purity of tantalum oxide or niobium oxide increases. They have also found that the decrease of purity is a main cause for the reduction of the whiteness of the powders. Moreover, they have made a complete check of the production process of tantalum oxide or niobium oxide powders and the color of the obtained powders. As a result, it was found that when impurities are eliminated, even though the amount of impurities eliminated is small, the whiteness of the powders increases. In contrast, when a very small amount of transition metal such as iron is mixed, the powders become lemon yellow.

On the other hand, even if the purity of the powders sufficiently high, the whiteness sometimes decreases. As a result of a complete check, it was found that a second cause for the reduction of the whiteness is the generation of a certain amount of tantalum or niobium oxide with reduced oxygen. The most stable oxidation state of tantalum oxide or niobium oxide is pentoxide, which is represented by rational formulas such as Ta₂O₅ or Nb₂O₅. If a certain amount of oxygen is deficient in a step of roasting tantalum or niobium hydroxide at a high temperature, oxygen is not sufficiently supplied, and some compounds with reduced oxygen are generated. The present inventors have assumed that this decreases the whiteness of the powders.

Thus, they have found that the stability of tantalum oxide or niobium oxide powders as pentoxide can be determined by determining the color of the powders, thereby completing the present invention.

That is to say, the present invention relates to tantalum oxide or niobium oxide powders, which have an extremely high lightness of color, having an L* value of 97 to 100 in an L*a*b* color system.

The term “L*a*b* color system” is used herein to mean a color indication method according to JIS Z 8729. The value of L* represents lightness, and the values of a* and b* represent hue and saturation using positive and negative values. In the chromaticity diagram of the L*a*b* color system, the larger the L* value is, the whiter the color that can be obtained, and the smaller the value is, the blacker the color that can be obtained. Moreover, the larger the positive a* value is, the redder the color that can be obtained, and the larger the negative a* value is, the greener the color that can be obtained. As the absolute value is small, the color becomes achromatic. Furthermore, the larger the positive b* value is, the more yellow the color that can be obtained, and the larger the negative b* value is, the bluer the color that can be obtained. As the absolute value is small, the color becomes achromatic.

The tantalum oxide or niobium oxide powders of the present invention are characterized in that they are powders having a particularly high whiteness. Their lightness is preferably an L* value of 97 to 100, and further preferably 99 to 100. Thus, an extremely high lightness of the tantalum oxide or niobium oxide powders shows that the powders have a stable pentoxide form of tantalum or niobium, as well as that the powders contain a small amount of impurities, e.g., transition metals such as iron, which cause the coloration of the powders.

The tantalum oxide or niobium oxide powders of the present invention having an extremely high whiteness are high-quality powders with high purity. The powders are preferably used as additive materials for optical glasses to obtain a high refractive index. The powders are also preferable as raw materials for lithium tantalate or lithium niobate single crystals, which require strictness in the composition ratio of the raw materials.

In addition to the above range of an L* value, the tantalum oxide or niobium oxide powders having an extremely high whiteness preferably have an a* value of −0.5 to +0.5 and a b* value of −0.5 to +0.5, which represent hue and saturation in an L*a*b* color system. Both a* and b* values are more preferably between −0.3 and +0.3. These tantalum oxide or niobium oxide powders have high purity and they are extremely stable as oxides, and therefore the quality of the powders is stable. Thus, the tantalum oxide or niobium oxide powders having an extremely high whiteness have a stable pentoxide form of tantalum oxide or niobium oxide, as well as having a low content of impurities.

A method of producing the above described tantalum oxide or niobium oxide powders of the present invention will be described below. This is to say, the production method comprises steps of adding ammonia to a hydrofluoric acid solution comprising tantalum and/or niobium so as to precipitate tantalum hydroxide and/or niobium hydroxide, separating the precipitated tantalum hydroxide and/or niobium hydroxide from the solution, and roasting the separated tantalum hydroxide and/or niobium hydroxide so as to obtain tantalum oxide and/or niobium oxide powders; the above method being characterized in that, in the roasting step, the tantalum hydroxide and/or niobium hydroxide is roasted at a roasting temperature of 500° C. to 1100° C., while oxygen-containing gas is flown as atmospheric gas, and an oxidation-promoting treatment to force the roasted product to come into contact with oxygen is carried out.

Thus, the production method of the tantalum oxide or niobium oxide powders of the present invention intends to produce high-quality niobium oxide powders by forcing a roasted product to come into contact with oxygen. The term “oxidation-promoting treatment” is used herein to mean, for example, a treatment to remove a roasted product with a high temperature obtained by roasting from a roasting furnace, or a treatment to break up and expose the removed roasted product to the air. Moreover, the oxidation-promoting treatment may also include a treatment to continuously rotate the roasting furnace after roasting so as to impart kinetic energy to the roasting products, tantalum hydroxide and/or niobium hydroxide during roasting. When such an oxidation-promoting treatment is carried out, the roasted product can be oxidized more reliably, and thereby high-purity high-quality tantalum oxide or niobium oxide powders with a high whiteness can be obtained. These powders are preferably used as additive materials for optical glasses to obtain a high refractive index. The obtained tantalum oxide and/or niobium oxide are disintegrated before use, as necessary.

The oxidation-promoting treatment is preferably carried out, when the temperature of the roasted product is 200° C. or higher. That is, if the above oxidation-promoting treatment is carried out in a period from the initiation of roasting to the completion of cooling of the roasted product, and when the temperature of the roasted product is 200° C. or higher, oxidation is carried out more effectively, and it is preferable. A method of handling the roasting product is limited during the roasting step, and for example, a roasting object should be placed in a roasting furnace that is heating means. In contrast, during the cooling step, the roasted product does not need to be heated, and it can be handled freely. In other words, the oxidation-promoting treatment that is carried out during the cooling step has an advantage in that means of effectively contacting the roasted product with oxygen can be selected and adopted relatively freely.

In addition to the oxidation-promoting treatment, a physical treatment to ensure a state in which the roasting objects, tantalum hydroxide and/or niobium hydroxide, come into contact with atmospheric gas may also be carried out. The term “physical treatment” is used herein to mean a treatment to ensure the contact state of a roasting object with atmospheric gas. The physical treatment is broadly divided into a treatment to carry out on a roasting object before roasting and a treatment to carry out on it after initiation of the roasting. When the roasting object is a cake of tantalum hydroxide and/or niobium hydroxide, examples of a physical treatment that is carried out before roasting may include a treatment to thinly spread the cake so that its thickness gets thin and the contact state with atmospheric gas is ensured, and a forming treatment to segmentalize the cake to a certain shape before roasting by forming means such as tablet compression. Examples of a physical treatment that is carried out after initiation of the roasting (during roasting) may include a treatment to rotate a roasting furnace so as to impart kinetic energy to tantalum hydroxide and/or niobium hydroxide. The treatment to physically impart kinetic energy to the above compound after initiation of the roasting has a significantly great effect of physical treatment, before the roasting temperature increases (e.g., the state at 150° C. or lower). In contrast, after the roasting temperature increases, a great effect of the above described oxidation-promoting treatment can be obtained.

If the above physical treatment is carried out so as to ensure the contact of a roasting object as a whole with atmospheric gas, the entire roasting product can reliably be oxidized during roasting, thereby obtaining high-purity, high-quality tantalum oxide or niobium oxide powders with a high whiteness, which are preferably used as additive materials for optical glasses so as to obtain a high refractive index. In particular, if the physical treatment is carried out before roasting, a roasting object such as the cake of tantalum hydroxide can reliably be come into contact with atmospheric gas from initiation of the roasting. It should be noted that the physical treatment carried out before roasting differs from that carried out during roasting in terms of the period when the treatment is carried out, and so both these treatments can be used in combination.

### BEST MODE FOR CARRYING OUT THE INVENTION

The embodiments of the present invention will be described below.

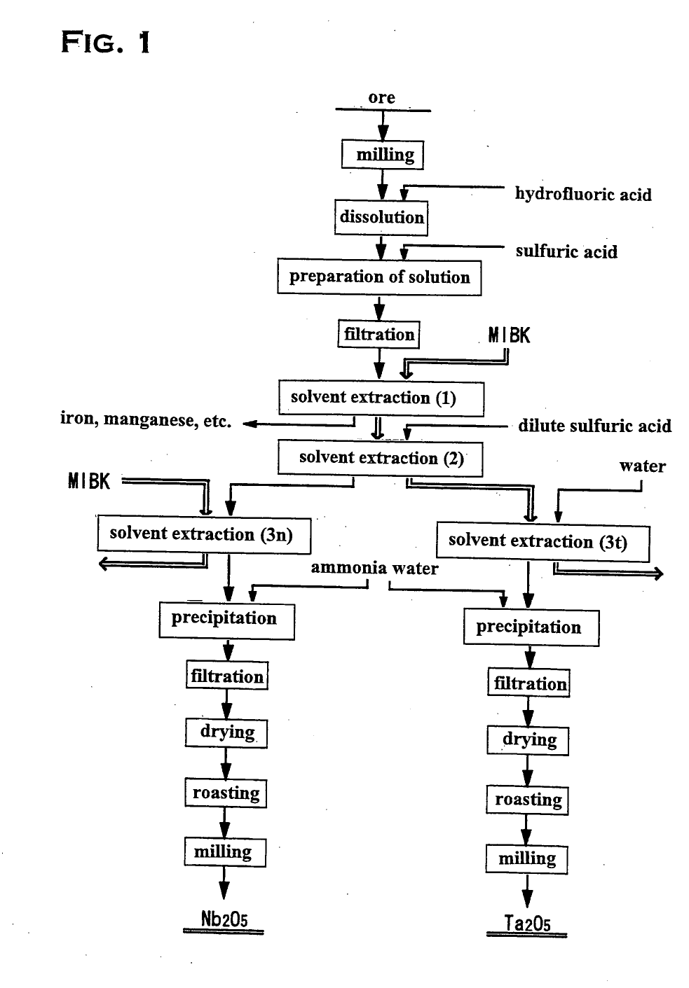

FIG. 1 shows a production process of the tantalum oxide or niobium oxide powders of the present invention.

The production process of the tantalum oxide or niobium oxide powers will be explained with reference to FIG. 1.

Firstly, in a milling step, ore such as columbite or tantalite used as a raw material is pulverized with a ball mill or the like so as to increase the dissolution rate of the ore.

In a dissolution step, the above obtained ore is placed in a dissolving tank, and it is dissolved with 80% hydrofluoric acid.

In a solution preparation step, the concentration of each of hydrofluoric acid and sulfuric acid is adjusted. When both tantalum and niobium are extracted in the following solvent extraction step, the concentration of the acids is adjusted such that free hydrofluoric acid is 1 to 10 mol/l and sulfuric acid is 3 to 5 mol/l.

In a filtration step, insoluble products are eliminated through a filter from a solution obtained in the above solution preparation step before the solution is supplied to the following solvent extraction step. A filter press is an example of the filter used herein.

Subsequently, solvent extraction is carried out by column method or mixer-settler method.

In a solvent extraction (1) step, a solution to be supplied to the solvent extraction step is come into contact with methyl isobutyl ketone (MIBK), so that tantalum or niobium in the solution to be supplied to the solvent extraction step are selectively extracted with MIBK. Impurities such as iron, manganese and silicon contained in the raw material ore are remained in the residual extraction solution and then eliminated.

In a solvent extraction (2) step, MIBK containing tantalum or niobium is subjected to stripping with dilute sulfuric acid, and niobium is transferred to an aqueous solution while tantalum is remained in MIBK, so that niobium is eliminated and pure tantalum is obtained.

In a solvent extraction (3t) step, tantalum in MIBK obtained in the solvent extraction (2) step is subjected to stripping with water, so as to obtain an aqueous solution of purified tantalum.

At the same time, in a solvent extraction (3n) step, niobium in the aqueous solution obtained in the solvent extraction (2) step is extracted with MIBK again, so that niobium in the aqueous solution is purified to obtain a pure product.

In a precipitation step, ammonia water is added to each of tantalum and niobium-containing aqueous solutions, which obtained in the solvent extraction (3t) and the solvent extraction (3n) steps, respectively, so as to adjust pH around 8, and thereby each of tantalum and niobium is deposited and precipitated as hydroxide.

In a filtration step, the precipitate of each of tantalum and niobium obtained in the above precipitation step is drawn out as slurry, and the slurry is then subjected to solid-liquid separation using a filter, so that each of tantalum and niobium is recovered as a hydroxide cake. A commonly used filter such as a vacuum filter can be used herein.

In a drying step, the hydroxide cake of each of tantalum and niobium obtained in the filtration step is heated to 80° C. to 180° C. to evaporate water contained in the cake. Commonly used dryers such as a rotary dryer, a hot air dryer and an infrared dryer can be used herein.

In a roasting step, after drying, the hydroxide of each of tantalum and niobium is roasted in the air under an acidic atmosphere at 500° C. to 1100° C. for 1 to 24 hours, so as to obtain each of tantalum oxide and niobium oxide. Herein, the roasting temperature is preferably 600° C. to 1000° C. in the production of tantalum oxide, and it is preferably 550° C. to 900° C. in the production of niobium oxide. If the roasting temperature is set at high, the roasting time can be reduced. However, if the roasting temperature is too high, tantalum and niobium pentoxides are likely to release oxygen, and thereby a stable pentoxide form cannot be obtained. Accordingly, the upper limit of the roasting temperature is more preferably 1000° C. for tantalum oxide, and 900° C. for niobium oxide. Thus, niobium oxide has a lower temperature range. This is because niobium oxide has a property that releases oxygen easily compared to tantalum oxide under condition of higher temperatures.

Commonly used roasting furnaces such as an electric furnace or a rotary kiln (rotary furnace) can be used in the roasting step.

In particular, a rotary kiln is preferably used because it enables a roasting product to fully come into contact with the air (to carry out a physical treatment) by rotating the furnace during roasting. When the rotary kiln is used, it is preferable to continue the rotation of the kiln even after roasting, so as to cool the roasted product while maintaining and promoting the contact of the product with the air in the kiln (to carry out an oxidation-promoting treatment). Thus, by fully contacting the roasted product with the air in the roasting furnace, a stable pentoxide form can be obtained.

When a static furnace such as an electric furnace is used, the undermentioned means (a physical treatment and an oxidation-promoting treatment) are preferably carried out. The following means bring about the good contact between the roasting product and the air, and thereby a stable pentoxide form of each of tantalum oxide and niobium oxide can be obtained.

The first means (physical treatment) is to thinly spread a roasting object such as a tantalum hydroxide cake that is obtained by filtration. By this means, the air can be supplied even to the inside of the roasting product. This method especially suits the production of a small amount of products. For the production of a relatively large amount of products, however, this method has a certain limitation in terms of industrial production.

The second means (physical treatment) is to segmentalize the roasting object cake obtained by filtration by forming. The term “forming” is used herein to mean the segmentalization of the cake into numerous pieces with a certain shape, so that the air passes well between and into the formed products. Examples of forming include pressing such as extrusion, die cutting or tablet compression; roll forming which comprises heating the inside of a drum having grooves, combining two of the drums, and pushing a cake therebetween for forming; and spray-drying forming which directly sprays slurry into high-temperature gas. When a hydroxide cake is formed by these methods, it is preferably to try not to generate much fines of a roasting object such as tantalum hydroxide. This is because there is a risk that such fines might prevent atmospheric gas from freely flowing between the formed products during roasting, thereby preventing promotion of oxidation. Specifically, it is preferable to carry out forming so that the ratio of fines with a size of 100 mesh or smaller is 20% or less by weight based on the total roasted objects, tantalum hydroxide and/or niobium hydroxide. Moreover, the formed product is preferably formed in such a way that the minimum distance of any part in the formed product from the outer air (i.e., the distance from any part in the formed product to the outer surface thereof) is below 10 mm. For example, if the formed product is spherical, its radius is preferably 10 mm or shorter, and if it is rectangular such as styroid, at least any one of “height (length), width, and depth” is preferably 20 mm or shorter.

The above described physical treatment is preferably carried out at least before a hydroxide as a roasting object is changed into an oxide (before completion of change), and generally, the treatment is carried out in a hydroxide state before roasting.

The third means (oxidation promoting treatment) is to cool the roasted product obtained by roasting, while allowing it to fully come into contact with oxygen-containing gas such as the air. As an example of the third means, oxygen-containing gas such as the air is supplied to a space such as a roasting furnace in which the roasted product to be cooled is placed. Moreover, examples of the third means include means of removing the roasted product from the roasting furnace after roasting and allowing it to come into contact with (be exposed to) the air (ambient air) during the cooling step before the product is cooled to room temperature, and means of breaking up the removed roasted product and exposing it to the air. Thus, when the roasted product is exposed to the air, it is preferable to remove the roasted product to be cooled from the roasting furnace, when the temperature of the product is between 100° C. and 600° C., and it is more preferably 200° C. or higher. Furthermore, another example of the oxidation-promoting treatment includes means of forcefully shredding (milling) the roasted product, e.g., by breaking up the product before it is cooled to room temperature, regardless of whether or not the product is removed from the roasting furnace. The reasons why these oxidation-promoting treatments are preferably carried out are considered to be as follows: If cooling is simply carried out in a closed space such as a roasting furnace, the air is not easily supplied to the roasted product. Further, a certain amount of oxygen is likely to be released from its pentoxide form, when it has a high temperature. Accordingly, a compound with few oxygen atoms is likely to be generated in the inside of the roasted product, wherein oxygen is hardly distributed. When a static furnace (electric furnace, etc.) is used, the roasting object, tantalum hydroxide or niobium hydroxide, should be placed in a boat or the like to roast it. Even if a forming treatment is carried out on the roasting object, oxygen is hardly distributed to a portion that is contacted with the boat. However, if the roasted product is removed from the furnace when it has a relatively high temperature, it is exposed to the air, and it is separated from the boat, oxygen is then fully supplied to the portion to which oxygen is hardly distributed, and thus, tantalum oxide or niobium oxide with a pentoxide form can be obtained with no shortage of oxygen.

The above described first, second and third means can widely be applied not only in the case of using a static furnace, but also in the case of using common roasting furnaces such as a rotary kiln.

In a milling step, the roasted product of tantalum oxide or niobium oxide is milled such that the agglutinated particles are broken up. Commonly used mills such as a ball mill and a vibration mill can be used herein.

The present invention will be described further in detail in the following examples.

### EXAMPLE 1

Ammonia water was added to a hydrofluoric acid solution comprising niobium so as to generate a niobium hydroxide precipitate. This precipitate was washed until the concentration of fluoride ions in the washing solution became 3000 ppm, and filtration was then carried out thereon, so as to obtain a niobium hydroxide cake. The obtained cake was placed in a high-purity quartz burning boat such that the thickness of the cake was approximately 5 mm (physical treatment), and it was roasted at 800° C. for 4 hours in an air current in an electric furnace. After roasting, the roasted product was cooled to 200° C. in the electric furnace, and thereafter, the roasted product with 200° C. was removed from the furnace (oxidation-promoting treatment). The roasted product was further cooled to room temperature, and thereafter, it was milled with a vibration mill to obtain niobium oxide powders.

### EXAMPLE 2

Extrusion (physical treatment) was carried out on a niobium hydroxide cake obtained in the same manner as in Example 1, so that a cake having a thickness of approximately 200 mm was obtained. The obtained cake was placed in a high-purity quartz burning boat, and it was then roasted at 1000° C. for 4 hours in an air current in an electric furnace. Thereafter, the roasted product was removed therefrom in the same manner as in Example 1, and it was then cooled to room temperature followed by milling, so as to obtain niobium oxide powders.

### EXAMPLE 3

Extrusion (physical treatment) was carried out on a niobium hydroxide cake that was obtained in the same manner as in Example 1, so that a cake having a thickness of approximately 200 mm was obtained. The obtained cake was placed in a high-purity quartz burning boat, and it was then roasted in an electric furnace in the same manner as in Example 1. After roasting, the roasted product was removed from the electric furnace, while it was at 600° C., and a treatment to break up the product (oxidation-promoting treatment) was carried out immediately. While the product was still hot, it was allowed to fully come into contact with the air, and it was then cooled. Thereafter, the product was milled in the same manner as in Example 1, so as to obtain niobium oxide powders.

### EXAMPLE 4

To produce niobium oxide, a rotary kiln was used instead of an electric furnace. A niobium hydroxide cake obtained in the same manner as in Example 1 was placed in the rotary kiln such that the cake represented a percentage of the internal volume of the sample tube of the kiln that was approximately 40%. While the cake was rotated at a rotation speed of 5 rpm (physical and oxidation-promoting treatments), it was roasted at 800° C. for 4 hours. That time, the sample tube was not hermetically sealed, so that the air was freely passed. After roasting, while continuously rotating the roasted product in the rotary kiln (oxidation-promoting treatment), it was naturally cooled to room temperature. Thereafter, the roasted product was milled with a vibration mill, so as to obtain niobium oxide powders.

### COMPARATIVE EXAMPLE 1

Extrusion (physical treatment) was carried out on a niobium hydroxide cake that was obtained in the same manner as in Example 1, so that a cake having a thickness of approximately 200 mm was obtained. The obtained cake was placed in a high-purity quartz burning boat, and it was then roasted in an electric furnace in the same manner as in Example 1. After roasting, the roasted product was naturally cooled to room temperature in the electric furnace. Thereafter, the product was milled in the same manner as in Example 1, so as to obtain niobium oxide powders.

### COMPARATIVE EXAMPLE 2

A niobium hydroxide cake obtained in the same manner as in Example 1 was roasted in an electric furnace, cooled, and milled so as to obtained niobium oxide powders, all in the same manner as in Example 1 with the exception that the thickness of the niobium hydroxide cake was approximately 200 mm and that the roasting temperature was set at 1200° C. in the electric furnace.

### COMPARATIVE EXAMPLE 3

Roasting, cooling and milling were carried out in the same manner as in Example 1 with the exception that when a cake having a thickness of approximately 5 mm that was obtained by the extrusion (physical treatment) of the niobium hydroxide cake obtained in the same manner as in Example 1 was placed in a high-purity quartz burning boat and then roasted in an electric furnace, nitrogen gas containing 1.0 vol % hydrogen was passed as atmospheric gas, so that niobium oxide powders were obtained.

Color Evaluation

The color of the niobium oxide powders obtained in each of Examples 1 to 4 and Comparative examples 1 to 3, that is, the values of L*, a*, and b* of the obtained niobium oxide powers in an L*a*b* color system were measured with a color difference meter (Minolta Co., Ltd., color difference colorimeter R-300), using standard illuminant C as a light source, and they were then evaluated. The results are shown in Table 1.

Production Test of Lithium Niobate Single Crystals

The niobium oxide powders obtained in each of Examples 1 to 4 and Comparative examples 1 to 3 were mixed with lithium carbonate powders at a ratio of 136.626 g:35.91 g (Li₂CO₃:Nb₂O₅=48.60:51.40 in mole ratio conversion). The obtained mixture was placed in a platinum crucible. This was melted by high-frequency heating, so as to prepare a melt. Thereafter, Czochralski process was carried out, setting a single crystal growth speed at 0.5 mm/hour and a rotation speed at 30 rpm, so as to produce lithium niobate single crystals. Table 1 shows the results of the appearance test on the single crystals that were pulled upward.

TABLE 1
<Roasting conditions for niobium oxide, color evaluation, and results
of production test of lithium niobate single crystals>

| | Thickness | | | | | | |
|---|---|---|---|---|---|---|---|
| | of niobium | Forming | | | | | |
| | hydroxide | treatment | | Roasting | Roasting | Temperature | |
| | cake | before | Burning | temperature | time | on removal | |
| | (mm) | roasting | atmosphere | (° C.) | (hr) | (° C.) | Remarks |
| Example 1 | 5 | Yes | Air | 800 | 4 | 200 | Cooled to room temperature after |
| | | | | | | | removal |
| Example 2 | 200 | Yes | Air | 1000 | 4 | 200 | Cooled to room temperature after |
| | | | | | | | removal |
| Example 3 | 200 | Yes | Air | 800 | 4 | 600 | Cooled to room temperature after |
| | | | | | | | removal, while breaking up the still- |
| | | | | | | | hot roasted product |
| Example 4 | — | No | Air | 800 | 4 | Room | Roasted in the rotary kiln, and then |
| | | | | | | temperature | cooled to room temperature while |
| | | | | | | | continuously rotating the kiln |
| Comparative | 200 | Yes | Air | 800 | 4 | Room | Cooled to room temperature in the |
| example 1 | | | | | | temperature | static furnace before removal |
| Comparative | 200 | No | Air | 1200 | 4 | 200 | Cooled to room temperature after |
| example 2 | | | | | | | removal |
| Comparative | 5 | Yes | Hydrogen 1 | 800 | 4 | 200 | Cooled to room temperature after |
| example 3 | | | vol % + | | | | removal |
| | | | nitrogen | | | | |

| | | | | Test results of production of |
|---|---|---|---|---|
| | Hue evaluation | | | LiNbO₃ single crystals |
| | L* | a* | b* | (Appearance) |
| Example 1 | 99.40 | 0.28 | 0.12 | Uniform and good |
| Example 2 | 98.51 | 0.15 | −0.22 | Uniform and good |
| Example 3 | 99.12 | 0.46 | 0.08 | Uniform and good |
| Example 4 | 99.87 | 0.12 | 0.09 | Uniform and good |
| Comparative | 96.84 | 0.53 | 0.31 | Nonuniform and twisted |
| example 1 | | | | |
| Comparative | 96.21 | 0.85 | −1.27 | Nonuniform and twisted |
| example 2 | | | | |
| Comparative | 94.47 | −0.12 | −2.81 | Cut during production |
| example 3 | | | | |

In Example 1, the thickness of a niobium hydroxide cake was set at 5 mm, and it was roasted under conditions shown in Table 1. The obtained niobium oxide powders had an extremely high whiteness, having an L* value of 99.40, an a* value of 0.28, and a b* value of 0.12.

On the other hand, Comparative example 1 was carried out under the same conditions as those of Example 1. These conditions include a forming treatment carried out before roasting, burning atmosphere, roasting temperature, and roasting time. However, the obtained niobium oxide powders had a low whiteness, having an L* value of 96.84, an a* value of 0.53, and a b* value of 0.31. It is considered that in Comparative example 1, since the roasted product was naturally cooled to room temperature in a furnace after roasting, a shortage of oxygen occurred in the roasted product, and a niobium oxide compound having reduced oxygen was obtained. As a result, it was found that even carrying out a forming treatment (physical treatment), if an oxidation-promoting treatment such as cooling the roasted product to room temperature in a furnace is not carried out, the obtained powders have a decreased whiteness, and thus, the powders become colored.

In Example 2, a niobium hydroxide cake was subjected to extrusion so as to set its thickness at approximately 200 mm, and the roasting temperature was set at 1000° C. The niobium oxide powders obtained in Example 2 had an even higher whiteness in spite. of somewhat lower L* value and a somewhat higher absolute b* value, when compared with the counterpart obtained in Example 1.

In contrast, in Comparative example 2, the thickness of a niobium hydroxide cake was simply set at 200 mm, and the roasting temperature was set at 1200° C. The obtained niobium oxide powders was somewhat blue, having an L* value of 96.21, an a* value of 0.85, and a b* value of −1.27. In Comparative example 2, roasting was carried out at a temperature higher than 500° C. to 1100° C. that is preferable as a roasting temperature, and niobium oxide thereby entered a state in which it easily released oxygen. It is therefore assumed that a shortage of oxygen in the roasting product progressed during a roasting period or a high-temperature period after roasting, and compounds with reduced oxygen were generated and colored. By comparing Example 2 with Comparative example 2, it was found that when a cake is thick, a physical treatment such as a forming treatment is effective to obtain white niobium oxide powders.

In Example 3, as with Comparative example 1, the thickness of a niobium hydroxide cake was set at 200 mm, and the roasting temperature was set at 800° C. However, after roasting, the roasted product was removed from the roasting furnace when it had a temperature of 600° C., and the still-hot product was cooled to room temperature while breaking up. Thereafter, as with Example 1, the product was milled, so as to obtain niobium oxide powders. The obtained niobium oxide powders had a high whiteness, having an L* value of 99.12, an a* value of 0.46, and a b* value of 0.08. Being different from Comparative example 1, in example 3, after roasting, the roasted product was not cooled to room temperature in the electric furnace, but an oxidation-promoting treatment was carried out such that the product was removed therefrom when it had a temperature of 600° C., and the still-hot product was broken up and then cooled to room temperature. This seems to be a reason for the above good results. It is assumed that as a result of the above treatment, oxygen was supplied to the inside of the roasted product, so that niobium oxide powders having a stable pentoxide form were obtained.

In Comparative example 3, a niobium hydroxide cake obtained in the same manner in Example 1 was subjected to extrusion so as to set its thickness at approximately 5 mm. The cake having a thickness of approximately 5 mm that was obtained by extrusion (physical treatment) was placed in a high-purity quartz burning boat, and the burning atmosphere was set to nitrogen gas containing 1.0 vol % hydrogen (reducing atmosphere). The obtained niobium oxide powders were per se, having an L* value of 94.47, an a* value of −0.12, and a b* value of −2.81. It is considered that since oxygen was deficient under the reducing atmosphere, a stable pentoxide form was not obtained, and thereby compounds with reduced oxygen were generated and became perse. From the above results, it was found that the whiteness of a roasted product decreases due to a shortage of oxygen. It was also found that gas containing oxygen such as the air (O₂ concentration: approximately 21%) is preferable as atmospheric gas for roasting.

In Example 4, roasting was carried out using a rotary furnace that is most preferable to obtain the niobium oxide powders of the present invention. The obtained niobium oxide powders had an extremely high whiteness, having an L* value of 99.87, an a* value of 0.12, and ab* value of 0.09. An oxidation-promoting treatment was carried out even at a high temperature during and after roasting, such that the rotary furnace was continuously rotated and the air was flown so as to fully distribute it in the inside of the roasted product, and thereby obtaining niobium oxide powders having a stable pentoxide form.

Moreover, from the results of Examples 3 and 4, it was found that it is preferable to carry out a treatment to allow the roasted product to come into contact with as large as possible amount of oxygen-containing gas during cooling the product after roasting, so as to promote oxidation (oxidation-promoting treatment).

The production test of lithium niobate single crystals was carried out using, as raw materials, the niobium oxide powders of Examples 1 to 4 that showed a high whiteness in the above color evaluation, and as a result, single crystals having a uniform thickness were obtained. On the other hand, the production test of the same above crystals was carried out using, as raw materials, the niobium oxide powders of Comparative examples 1 to 3 that showed a low whiteness in the above color evaluation. As a result, when the powders of Comparative example 1 were used, torsion was generated in the obtained crystals. When those of Comparative example 2 were used, torsion was frequently generated and the obtained crystals were nonuniform. Further, when the powders of Comparative example 3 were used, single crystals were cut when they were pulled upwards. From the above results, it was found that niobium oxide powders having a high whiteness are preferable for the production of lithium niobate single crystals.

### EXAMPLE 5

Ammonia water was added to a hydrofluoric acid solution comprising tantalum so as to generate a tantalum hydroxide precipitate. This precipitate was washed until the concentration of fluoride ions in the washing solution became 3000 ppm or lower, and filtration was carried out thereon, so as to obtain a tantalum hydroxide cake. The obtained cake was placed in a high-purity quartz burning boat such that the thickness of the cake was approximately 5 mm (physical treatment), and it was roasted at a roasting temperature of 1000° C. for 6 hours in an air current in an electric furnace. After roasting, the roasted product was cooled to 200° C. in the electric furnace. Then, the product was removed from the furnace, and it was further cooled to room temperature. Thereafter, the product was milled with a vibration mill, so as to obtain tantalum oxide powders.

### EXAMPLE 6

Extrusion (physical treatment) was carried out on a tantalum hydroxide cake obtained in the same manner as in Example 5. The obtained cake was placed in a high-purity quartz burning boat such that the thickness of the cake was approximately 100 mm, and it was then roasted in an electric furnace in the same manner as in Example 5. After roasting, the roasted product was removed from the electric furnace while it was at 600° C. Then, the product was immediately broken up, and the still-hot product was allowed to come into full contact with the air for cooling. Thereafter, the product was milled with a vibration mill in the same manner as in Example 5, so as to obtain tantalum oxide powders.

### COMPARATIVE EXAMPLE 4

Tantalum oxide powders were obtained in the same manner as in Example 5 with the exception that the thickness of a tantalum hydroxide cake obtained in the same manner as in Example 5 was set at 100 mm and that after roasting, the roasted product was naturally cooled to room temperature in a furnace.

Color Evaluation

The color of the tantalum oxide powders obtained in each of Examples 5 and 6, and Comparative example 4, that is, the values of L*, a*, and b* of the obtained tantalum oxide powers in an L*a*b* color system were measured with a color difference meter (Minolta Co., Ltd., color difference colorimeter R-300), using standard illuminant C as a light source, and they were then evaluated. The results are shown in Table 2.

Production Test of Lithium Niobate Single Crystals

The tantalum oxide powders obtained in each of Examples 5 and 6 and Comparative example 4 were mixed with lithium carbonate powders at a ratio of 227.133 g:35.91 g (Li₂CO₃:Ta₂O₅=48.60:51.40 in mole ratio conversion). The obtained mixture was placed in a platinum crucible. This was melted by high-frequency heating, so as to prepare a melt. Thereafter, Czochralski process was carried out, setting a single crystal growth speed at 0.5 mm/hour and a rotation speed at 30 rpm, so as to produce lithium tantalate single crystals. Table 2 shows the results of the appearance test on the single crystals that were pulled upward.

TABLE 2
<Roasting conditions for tantalum oxide, color evaluation, and results
of production test of lithium tantalate single crystals>

| | Thickness | | | | | | |
|---|---|---|---|---|---|---|---|
| | of | | | | | | |
| | tantalum | Forming | | | | | |
| | hydroxide | treatment | | Roasting | Roasting | Temperature | |
| | cake | before | Burning | temperature | time | on removal | |
| | (mm) | roasting | atmosphere | (° C.) | (hr) | (° C.) | Remarks |
| Example 5 | 5 | Yes | Air | 1000 | 6 | 200 | Cooled to room temperature after |
| | | | | | | | removal |
| Example 6 | 100 | Yes | Air | 1000 | 6 | 600 | Cooled to room temperature after |
| | | | | | | | removal, while breaking up the still- |
| | | | | | | | hot roasted product |
| Comparative | 100 | No | Air | 1000 | 6 | Room | Cooled to room temperature in the |
| example 4 | | | | | | temperature | static furnace before removal |

| | | | | Test results of production of |
|---|---|---|---|---|
| | Hue evaluation | | | LiTaO₃ single crystals |
| | L* | a* | b* | (Appearance) |
| Example 5 | 99.58 | 0.25 | 0.17 | Uniform and good |
| Example 6 | 99.73 | 0.47 | 0.09 | Uniform and good |
| Comparative | 95.83 | 0.67 | 0.38 | Nonuniform and twisted |
| example 4 | | | | |

In Example 5, the thickness of a tantalum hydroxide cake was set at 5 mm, and it was roasted under conditions shown in Table 2. The obtained tantalum oxide powders had an extremely high whiteness, having an L* value of 99.58, an a* value of 0.25, and a b* value of 0.17.

On the other hand, Comparative example 4 was carried out under the same conditions as those of Example 5. These conditions include burning atmosphere, roasting temperature, and roasting time. However, the obtained tantalum oxide powders had a low whiteness, having an L* value of 95.83, an a* value of 0.67, and a b* value of 0.38. It is considered that in Comparative example 4, since the thickness of a tantalum hydroxide cake was set at 100 mm that was thicker than the cake of Example 5 (5 mm), a shortage of oxygen occurred in the roasting product during and after roasting, and a tantalum oxide compound having reduced oxygen was obtained. Moreover, it is also considered that natural cooling of the roasted product to room temperature in a furnace is another reason for the shortage of oxygen in the roasted product.

In Example 6, the thickness of a tantalum hydroxide was set at 100 mm. The obtained tantalum oxide powder has a high whiteness, having an L* value of 99.73, an a* value of 0.47, and a b* value of 0.09. Being different from Comparative example 4, in example 6, after roasting, the roasted product was not cooled to 200° C. in the electric furnace, but the product was removed therefrom when it had a temperature of 600° C., and the still-hot product was broken up and then cooled to room temperature. This seems to be a reason for the above good results. It is assumed that as a result of the above treatment, oxygen was supplied to the inside of the roasted product, so that tantalum oxide powders having a stable pentoxide form were obtained.

The production test of lithium tantalate single crystals was carried out using, as raw materials, the tantalum oxide powders of Examples 5 and 6 that showed a high whiteness in the above color evaluation, and as a result, single crystals having a uniform thickness were obtained. On the other hand, the production test of the same above crystals was carried out using, as raw materials, the tantalum oxide powders of Comparative example 4 that showed a low whiteness in the above color evaluation. As a result, torsion was frequently observed in the produced crystals. From the above results, it was found that tantalum oxide powders having a high whiteness are preferable for the production of lithium tantalate single crystals.

### Industrial Applicability

According to the present invention, tantalum oxide or niobium oxide powders with an extremely high whiteness are obtained, wherein an L* value is between 97 and 100, an a* value is between −0.5 and +0.5, and a b* value is between −0.5 and +0.5 in an L*a*b* color system; and the present invention thereby provides high-quality tantalum oxide or niobium oxide powders having a stable pentoxide form. These tantalum oxide or niobium oxide powders with a high whiteness are preferable as raw materials used in the production of lithium tantalate or lithium niobate single crystals, which requires strictness in the composition ratio of the raw materials. The use of these powders improves the yield in the production of the single crystals. Moreover, these tantalum oxide or niobium oxide powders with a high whiteness are preferable as additive materials for optical glasses. When these powders are used, an optical glass with a high refractive index can be obtained.

1. Tantalum oxide or niobium oxide powders, wherein an L* value is from 97 to 100 both inclusive in the L*a*b* color system.

2. The tantalum oxide or niobium oxide powders according to claim 1, wherein an a* value is from −0.5 to +0.5 both inclusive and a b* value is from −0.5 to +0.5 both inclusive in the L*a*b* color system.

3. A method of producing tantalum oxide and/or niobium oxide powders, which comprises steps of adding ammonia to a hydrofluoric acid solution comprising tantalum and/or niobium so as to precipitate tantalum hydroxide and/or niobium hydroxide, separating the precipitated tantalum hydroxide and/or niobium hydroxide from the solution, and roasting the separated tantalum hydroxide and/or niobium hydroxide so as to produce tantalum oxide and/or niobium oxide powders;
said method being characterized in that, in the roasting step, the tantalum hydroxide and/or niobium hydroxide is roasted at a roasting temperature of 500° C. to 1100° C., while oxygen-containing gas is flown therethrough as atmospheric gas, and
an oxidation-promoting treatment to force the roasted product to come into contact with oxygen is carried out.

4. The method of producing tantalum oxide and/or niobium oxide powders according to claim 3, wherein the oxidation-promoting treatment starts when the temperature of the roasted product is 200° C. or higher.

5. The method of producing tantalum oxide and/or niobium oxide powders according to claim 3 or 4, which further comprises a step of carrying out a physical treatment to ensure a state in which the roasting objects, tantalum hydroxide and/or niobium hydroxide, come into contact with the atmospheric gas.

6. The method of producing tantalum oxide and/or niobium oxide powders according to claim 3, wherein the physical treatment is carried out at least before completion of the roasting.
